(19) United States
(12) Patent Application Publication
(10) Pub. No.: US 2007/0143272 A1
(43) Pub. Date: Jun. 21, 2007

(54) METHOD AND APPARATUS FOR RETRIEVING SIMILAR IMAGE

(76) Inventor: Koji Kobayashi, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/611,530

(22) Filed: Dec. 15, 2006

(30) Foreign Application Priority Data
Dec. 16, 2005 (JP) 2005-362728

(51) Int. Cl. G06F 17/30

(52) U.S. Cl. 707/3

(57) ABSTRACT

A similarity calculation processing unit calculates a similarity between a query image and each of a plurality of retrieval target images by using a layout feature amount and an image-property feature amount relating to the query image and the retrieval target image, and ranks the retrieval target images in descending order of similarity. When calculating the similarity, the layout feature amount is assigned with a heavier weight than the image-property feature amount.

### CROSS-REFERENCE TO RELATED APPLICATIONS

The present document incorporates by reference the entire contents of Japanese priority document, 2005-362728 filed in Japan on Dec. 16, 2005.

### BACKGROUND OF THE INVENTION

1. Field of the Invention

The present invention relates to a technology for retrieving similar image.

2. Description of the Related Art

In the image retrieval apparatus disclosed in Japanese Patent Application Laid-Open No. 2000-285141, for example, three feature amounts a, b, and c are used for calculation of similarity between images. When retrieval is performed, a query image A related to the feature amount a, a query image B related to the feature amount b, and a query image C related to the feature amount c are specified. For example, when the feature amount a is a color feature amount, an image having a color scheme appearance similar to that of the target image is specified as the query image A, when the feature amount b is an edge feature amount, an image having a structural appearance similar to that of the target image is specified as the query image B, and when the feature amount c is a texture feature amount, an image having a texture appearance similar to that of the target image is specified as the query image C. Then, the feature amounts a, b, and c are extracted from the query images A, B, and C, similarities (distances) of the feature amounts a, b, and c are calculated between a retrieval target image (database registration image) and the query image, respectively, and these similarities are summed up to determine a total similarity (distance). When these similarities are summed up, a mode in which weights are assigned to the feature amounts a, b, and c, respectively, is also described.

In the information processor disclosed in Japanese Patent Application Laid-Open No. 2004-348706, an image is divided into regions for every block of attribute. Then, a position between the blocks corresponding to the input image and a registered image (electronic data), a size therebetween, an attribute therebetween, and similarity ratios of feature amounts such as color and texture inside the block are determined. Similarity ratios in all blocks are summed up to determine a total similarity ratio, and a weight is assigned according to the occupancy in the block at that time.

In the image retrieval apparatus disclosed in Japanese Patent Application Laid-Open No. 2003-330965, a keyword and layout information are specified at the time of retrieval. Indexes of registered images include keyword and layout information. Layout information is specified by selecting, for example, models (menu) such as the presence or absence of title, the presence or absence of multicolumn layout, and the presence or absence of table. Indexes are searched for using a keyword and layout information, and electronic data matching with the conditions is specified.

Although devices for electronic filing and the like to electronize paper documents with the use of an input device such as scanner have conventionally existed, the devices are only used for business uses handling paper documents in a large quantity. However, reduced cost of scanner, prevalence of multi function peripheral (MFP) equipped with scanning function, and legislation of Electronic Documents Act (Personal Information Protection and Electronic Documents Act) have made the excellent handling and convenience thereof recognized popularly, thereby increasing opportunities of electronization of paper documents by scanning.

Further, the use of image database is increasing by way of creating database (hereinafter, “DB”) of electronized document image data for management at the same time as scanning paper documents. For example, it sometimes takes place to construct image DB in view of easy management even though an original of paper document is needed to keep. In such document image DBs, there are various ones from a large scale DB to which a number of people access through a server apparatus to a DB for personal use that DB is constructed in personal computer. Furthermore, there is a case in which current MFPs are provided with a function to accumulate documents in built-in hard disk drive (HDD) and a document image DB is constructed with the use of MFP as the base.

In such document image DBs, some of them are provided with a retrieval function to retrieve a desired document image from a large quantity of document images. Current main retrieval functions generally carry out text-based full-text search, concept search, and the like using a keyword throughout results recognized by optical character reader (OCR) processing. However, in such text-based search, there are problems as follows:

(1) Dependence on the accuracy of OCR;

(2) Necessity of a search keyword; and

(3) Difficulty in narrowing-down when there are a number of hits.

Regarding the problem (1), it is impossible to obtain 100% accuracy by OCR in the present state, and therefore, when OCR makes a mistake in part of the input search keyword, a problem that nothing is hit arises. Regarding the problem (2), when text-based search is carried out, the efficiency thereof is high when, for example, an unknown matter such as in home page on the Internet is searched for or a keyword of the search is definite. On the other hand, for example, when a document that was input several years ago and the memory thereof is uncertain is searched for, it is impossible to search for it unless an appropriate keyword therefor comes to mind. Further, it is impossible to search for a document whose entire page is a photograph or graphics with no text. Regarding the problem (3), when text-based search is carried out, ranking is difficult, and therefore, hits with the keyword are treated equally. Because of this, when the number of hits is large, it is necessary to verify a number of hit document images one by one, which is poor in usability.

On the other hand, there is a technology to retrieve a similar image using features of the image. The apparatuses disclosed in Japanese Patent Application Laid-Open No. 2000-285141 and Japanese Patent Application Laid-Open No. 2004-348706 are examples of the technology. However, in the case of the apparatus disclosed in Japanese Patent Application Laid-Open No. 2000-285141, elements such as figure, table, photograph, and text in a document image are handled at the same level, an expected ranking result cannot often be obtained. Further, in the case of the apparatus disclosed in Japanese Patent Application Laid-Open No. 2004-348706, a similarity for every object in the divided region is calculated and the total similarity is calculated, which gives rise to a problem that, for example, a document having the same photograph as that of a target document is searched for as a document with a high similarity even though the contents of the document are different from those of the target document other than the same photograph.

Furthermore, the image retrieval apparatus disclosed in Japanese Patent Application Laid-Open No. 2003-330965 narrows down images by specifying a keyword and layout information. Since it is not easy for ordinary users to specify appropriate layout information, a method of selecting a model (menu) of layout is described in the patent document. However, when narrowing-down of a small number of document images is attempted according to the layout information, a number of layout models need to be prepared, which gives rise to complicate selection and difficult use. In addition, when the number of layout models becomes small, efficient narrowing-down of document becomes impossible. Further, there are constraints as described above with respect to text-based search using a keyword.

When a target image is retrieved from image database relying on an uncertain memory about the target image, it is difficult to use the same image as the target image or an image whose part has the same element as that of the target image as a query image. Thus, the similarity of the whole appearance of the image becomes more important than the similarity of the object. Such a respect is not taken into consideration in apparatuses such as those disclosed in Japanese Patent Application Laid-Open No. 2000-285141 and Japanese Patent Application Laid-open No. 2004-348706.

### SUMMARY OF THE INVENTION

It is an object of the present invention to at least partially solve the problems in the conventional technology.

According to an aspect of the present invention, a method of retrieving similar image includes calculating a similarity between each of a plurality of retrieval target images and a query image by using a layout feature amount and an image-property feature amount, the layout feature amount being a feature amount related to layout obtained from the retrieval target images and the query image, and the image-property feature amount being a feature amount related to properties other than the layout, wherein the layout feature amount is assigned with a heavier weigh than the image-property feature amount at the time of calculating the similarity; and ranking the retrieval target images in descending order of similarities calculated at the calculating.

According to another aspect of the present invention, a method of retrieving similar image includes first calculating including calculating a similarity between each of a plurality of retrieval target images and a query image by using a layout feature amount, the layout feature amount being a feature amount related to layout obtained from the retrieval target images and the query image; ranking the retrieval target images in descending order of similarities calculated at the first calculating; dividing the retrieval target images that are ranked at the ranking into at least two groups in a predetermined number on a ranking basis; second calculating including calculating, for each group, a similarity between each of a plurality of retrieval target images in the group and the query image by using an image-property feature amount, the image-property feature amount being a feature amount related to properties other than the layout obtained from the retrieval target images and the query image; and ranking the retrieval target images in the group in descending order of similarities calculated at the second calculating.

According to still another aspect of the present invention, a similar image retrieval apparatus includes a similarity calculating unit that calculates a similarity between each of a plurality of retrieval target images and a query image by using a layout feature amount and an image-property feature amount, the layout feature amount being a feature amount related to layout obtained from the retrieval target images and the query image, and the image-property feature amount being a feature amount related to properties other than the layout, wherein the layout feature amount is assigned with a heavier weigh than the image-property feature amount at the time of calculating the similarity; and a ranking unit that ranks the retrieval target images in descending order of similarities calculated by the similarity calculating unit.

According to still another aspect of the present invention, a similar image retrieval apparatus includes a first calculating unit that calculates a similarity between each of a plurality of retrieval target images and a query image by using a layout feature amount, the layout feature amount being a feature amount related to layout obtained from the retrieval target images and the query image; a first ranking unit that ranks the retrieval target images in descending order of similarities calculated by the first calculating unit; a dividing unit that divides the retrieval target images that are ranked by the first ranking unit into at least two groups in a predetermined number on a ranking basis; a second calculating unit that calculates, for each group, a similarity between each of a plurality of retrieval target images in the group and the query image by using an image-property feature amount, the image-property feature amount being a feature amount related to properties other than the layout obtained from the retrieval target images and the query image; and a second ranking unit that ranks the retrieval target images in the group in descending order of similarities calculated by the second calculating unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a system according to a first embodiment;

FIG. 2 is a block diagram of hardware structure of a computer;

FIGS. 3A and 3B are schematics for explaining layout analysis;

FIG. 4 is a block diagram of a layout-feature-amount calculation processing unit;

FIGS. 5A to 5C are diagrams for explaining image division for layout feature amount calculation;

FIG. 6 is a block diagram of an image-property feature-amount calculation processing unit;

FIG. 7 is a flowchart for explaining an image registration operation;

FIG. 8 is a flowchart for explaining a similar image retrieval operation;

FIG. 9 is a conceptual diagram of similarity calculation in feature space;

FIG. 10 is a block diagram of a system structure according to a second embodiment of the present invention;

FIG. 11 is a detailed diagram to explain stepwise ranking using layout similarity and image property similarity;

FIG. 12 is a block diagram of a system structure according to a third embodiment of the present invention;

FIG. 13 is a detailed diagram to explain a layout image according to a method of filling in with textures; and

FIG. 14 is a diagram to explain correlation of attribute similarities of objects with filled-in data values of the objects.

### DETAILED DESCRIPTION OF THE PREFERRED EMBODIMENTS

Exemplary embodiments of the present invention are explained using several examples.

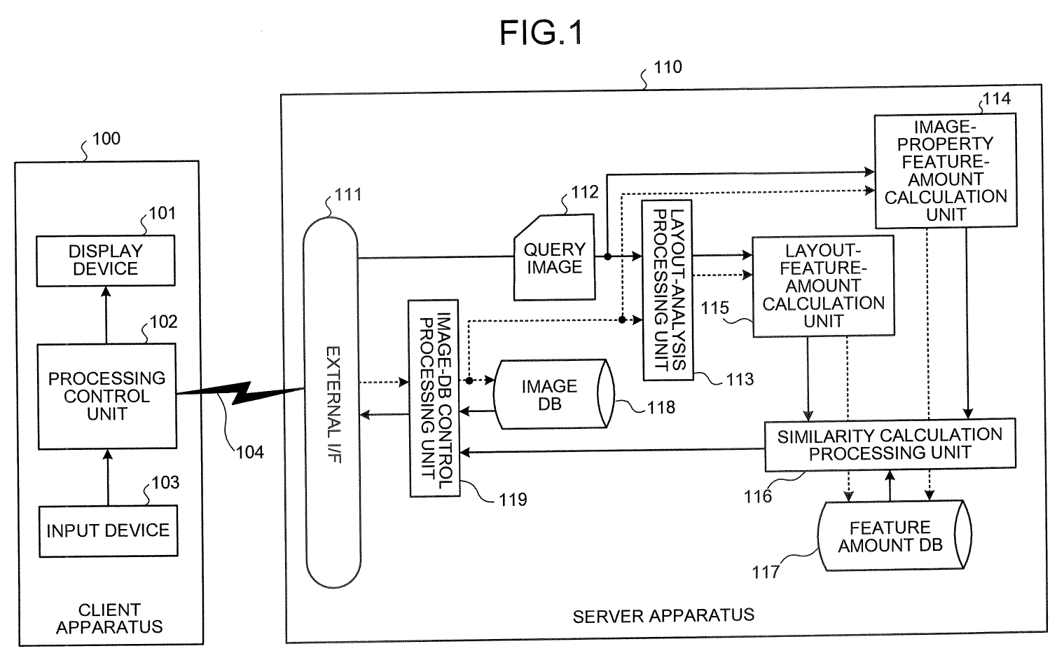

FIG. 1 is a block diagram of a similar image retrieval apparatus according to a first embodiment of the present invention. The similar image retrieval apparatus includes a client apparatus 100 and a server apparatus 110 that are connected to each other via an external communication channel 104, such as wired/wireless local area network (LAN) or the Internet. As described later, the similar image retrieval apparatus is not necessarily limited to this kind of server and client structure.

The client apparatus 100 includes an input device 103 that is an unit to input instructions from a user, a display device 101 that is an unit to display images and other information as search results, and a processing control unit 102 that is an unit to interpret the instructions input by the user, communicate with the server apparatus 110, and control the display device 101.

The client apparatus 100 is specifically, for example, a computer such as personal computer (PC) and mobile terminal such as personal digital (data) assistants (PDA) and a portable phone, and the processing control unit 102 is realized as application program operated by a computer incorporated in the PC, the mobile terminal, or the like.

The server apparatus 110 retrieves similar images according to a command from the client apparatus 100 to output the search result to the client apparatus 100 and has a structure including an image database (DB) 118, a feature amount database (DB) 117, an image-DB control processing unit 119, a similarity calculation processing unit 116, a layout analysis processing unit 113, a layout-feature-amount calculation processing unit 115, an image-property feature-amount calculation processing unit 114, and an external interface 111 that is an interface with the external communication channel 104.

The layout analysis processing unit 113 is an unit that not only converts layout into objects by analyzing the layout of an image and dividing the image elements into regions but also determines attributes of the objects and outputs layout information as the result. The layout-feature-amount calculation processing unit 115 is an unit that calculates feature amounts (layout feature amounts) related to the layout of the image from the layout information output from the layout analysis processing unit 113. The image-property feature-amount calculation processing unit 114 is an unit that calculates feature amounts (image property feature amounts) related to properties of the image other than the layout of the image.

The image DB 118 is a database in which images are registered. The feature amount DB 117 is a database in which data of an image property feature amount and a layout feature amount calculated by the image-property feature-amount calculation processing unit 114 and the layout-feature-amount calculation processing unit 115, respectively, in respect of each image registered in the image DB 118 is correlated with the registered image and stored. For example, a registered image and the feature amount data related thereto are given the same identification information (ID) to be managed.

The similarity calculation processing unit 116 is an unit that calculates a similarity between a query image (an image registered in the image DB 118 or an unregistered image input from the outside) and a registered image from the feature amounts related to the query image and the feature amounts related to each registered image, selects up to a predetermined number of registered images with high similarities as similar images, and ranks these similar images in descending order of similarity. Information on these ranked similar images is output from the similarity calculation processing unit 116 to the image-DB control processing unit 119. Here, an explanation is given assuming that the information is output after the ID of each similar image (registered image) is ranked. The image-DB control processing unit 119 is an unit that controls registration of images to the image DB 119, read-out of images therefrom, and the like.

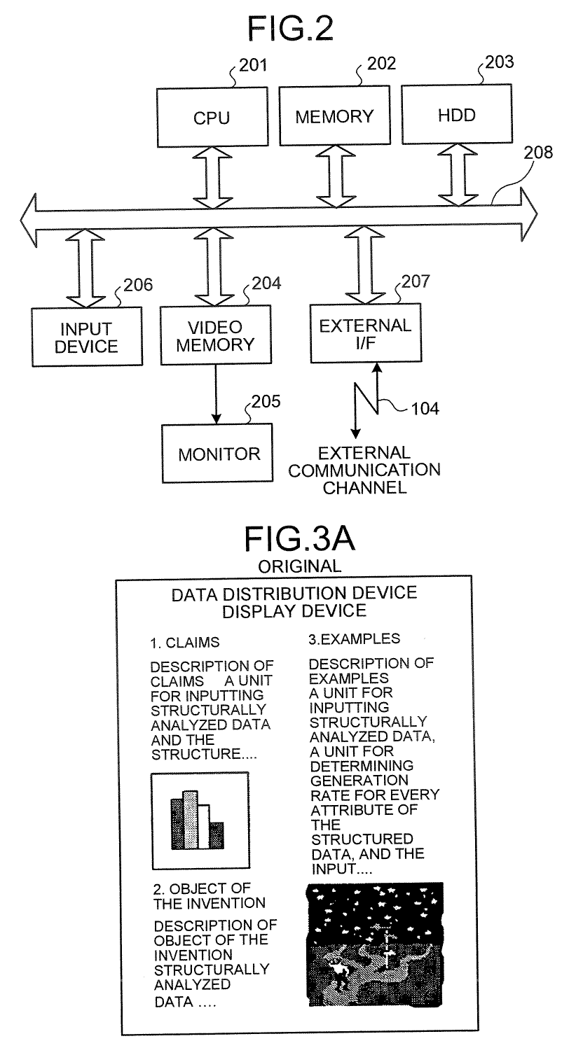

The server apparatus 110 like this is realized, for example, by software on a computer shown in FIG. 2. In FIG. 2, the reference numeral 201 represents a central processing unit (CPU) that performs calculation and processing according to a program, 202 represents a volatile memory used to temporarily store data such as codes of programs and image code data, 203 represents a hard disk that stores therein image data, computer programs, and the like, 205 represents a monitor, and 204 represents a video memory for accumulate data for display on the monitor 205. Image data written in the video memory 204 is periodically displayed on the monitor 205. The reference numeral 206 represents an input device such as mouse and keyboard, 207 represents an external interface that sends and receives data via the external communication channel 104 such as the Internet and LAN, and 208 represents a bus to interconnect each component described above. In a computer like this, the image DB 118 and the feature amount DB 117 would be stored in the hard disk 203. An application program that allows a computer to function as each of the units 113, 114, 115, 116, and 119 of the server apparatus 110 is loaded, for example, into the memory 202 from the hard disk 203 and executed by the CPU 201, thereby operating the computer as the server apparatus 110. Various information recording media (memory) that are readable by a computer such as magnetic disk, optical disk, magneto-optic disk, semiconductor memory device in which the program as described above and a similar program are recorded are also included in the present invention. This is the same in the server apparatus 110 according to a second embodiment and a third embodiment of the present invention.

Similarly, the client apparatus 100 is also realized as described above by software using hardware of a computer such as PC and a computer incorporated in a mobile terminal or the like. A program for that purpose and various information recording (memory) media recorded with the program are also included in the present invention. Note that this is the same in the client apparatus 100 according to the second embodiment and the third embodiment of the present invention.

It is also possible to install the server apparatus 110 in an apparatus like a multi function printer (MFP) or the like as hardware or software. Further, the image retrieval system according to the first embodiment can also be constructed so that the components in FIG. 1 are installed in, for example, one apparatus such as PC and MFP integrally without separating the server apparatus and the client apparatus. This is the same in the second embodiment and the third embodiment of the present invention.

The layout analysis processing unit 113 will be explained next. The layout analysis processing unit 113 generates layout information by dividing an image into image element units (objects) by way of layout analysis of the image as well as determining an attribute of each object.

Layout analysis processing like this is often used in pre-processing and the like for OCR processing, and various techniques for that have been disclosed. These well-known techniques can be employed for the layout analysis processing. For example, the technique as disclosed in Japanese Patent Application Laid-Open No. 2001-297303 that identifies the character region and photograph region by specifying a background color of a document image, extracting pixels other than the background region from the document image using the background color, integrating the pixels to generate linked components, and sorting the linked components to predetermined regions with the use of at least the shape feature can be used. Further, for the identification of character region, for example, the technique as disclosed in Japanese Patent Application Laid-Open No. 7-73271 (1995) that identifies the character region using the shape of circumscribed rectangle after carrying out adaptive binarization processing can also be used. Furthermore, the technique as disclosed in Japanese Patent Application Laid-Open No. 7-221968 (1995) that analyzes the adjacent relation of the black region of image to separate into rectangles and identifies each region of character, photograph, graphics, and table of the image based on the size of the rectangle and the distribution density of the black region can also be used. By using such well-known techniques (or in combination thereof), region division (conversion to objects) for every attribute of character region, photograph region, graphics region, table region, or the like and determination of the attribute thereof become possible. Still further, when identification of a title region and the like are carried out based on the position and size of the character region and the size of character at this time, the accuracy of similarity determination at the time of similar image retrieval can be enhanced.

For the determination of attributes of the divided objects, for example, a histogram, a feature amount like frequency, and the like of a divided region is obtained, and then a pattern recognition technique such as neural network or support vector machine that has been allowed to learn relation between feature amounts and attributes may be used. Further, prior to the layout analysis processing, in order to enhance its accuracy, it is more preferred to carry out pre-processing such as skew correction and removal of set-off from the input image.

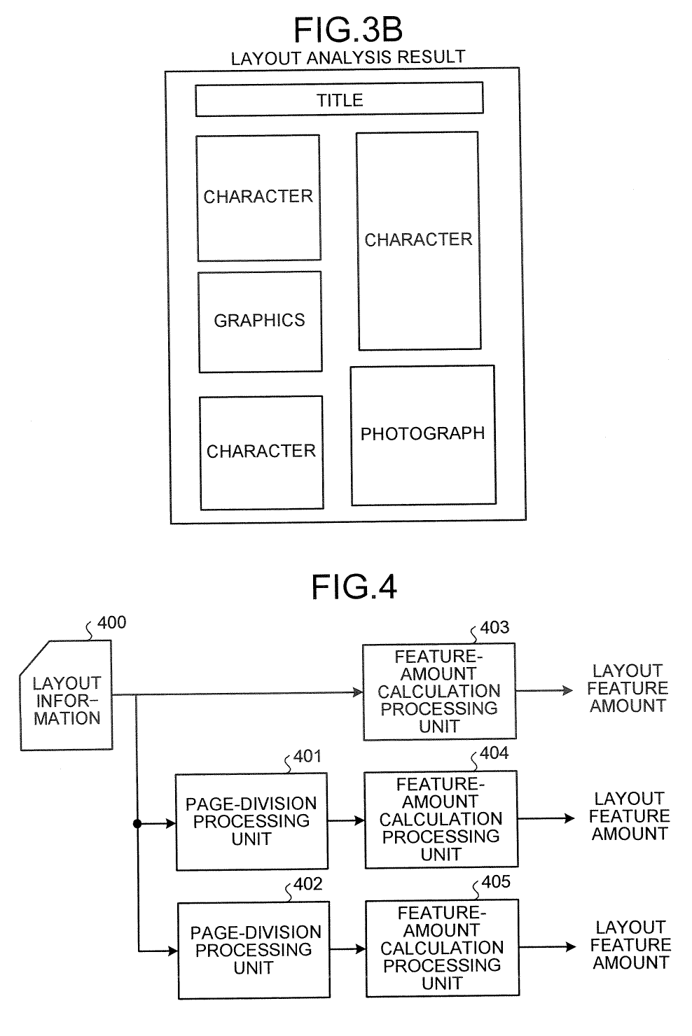

An example of the above layout analysis is shown in FIGS. 3A and 3B. FIG. 3A represents an input image (original), and FIG. 3B represents the layout analysis result thereof. In this example, the image is divided into six objects having attribute of title, character, graphics, and photograph.

The layout-feature-amount calculation processing unit 115 will be explained next. The layout-feature-amount calculation processing unit 115 divides the whole image (page) into different numbers of divisions, and a feature amount for every divided region for each number of divisions is calculated from layout information. This number of division can include one. That is, a feature amount of the whole image can be obtained as one divided region.

The functional structure of the layout-feature-amount calculation processing unit 115 when the numbers of divisions are one, four, and twelve and when a layout feature amount for each number of divisions is calculated is shown in FIG. 4. In FIG. 4, the reference numerals 401 and 402 represent page-division processing units, respectively, and the reference numerals 403, 404, and 405 are feature-amount calculation processing units, respectively.

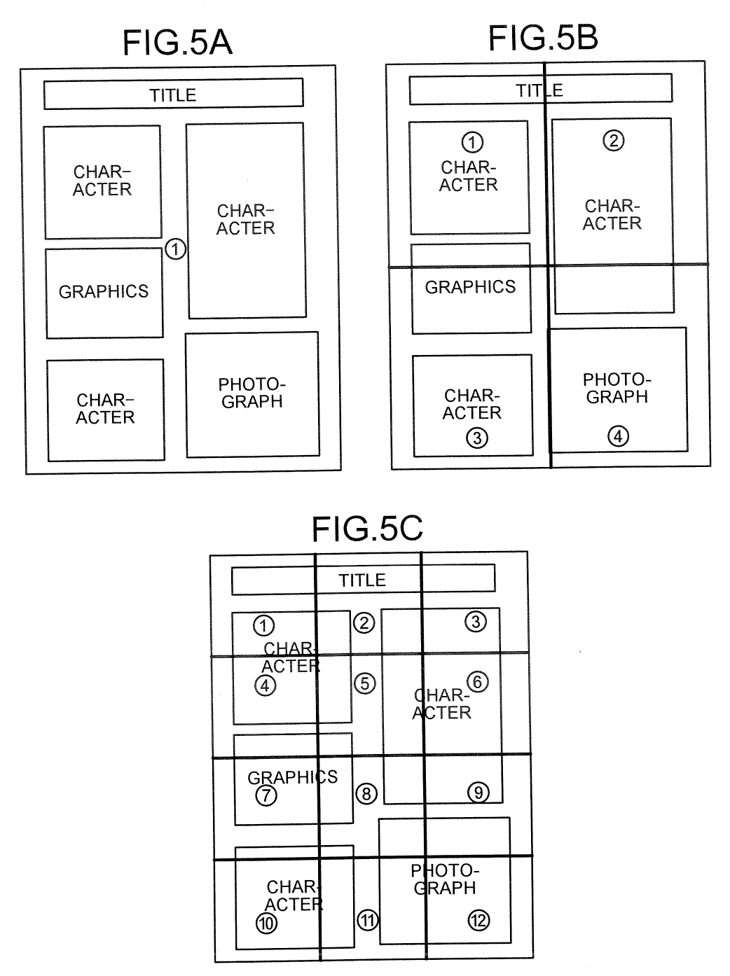

Layout information 400 per page output from the layout analysis processing unit 113 is input and this is schematically shown in FIG. 5A. This layout information is input to the feature-amount calculation processing unit 403 as it is. In other words, the feature-amount calculation processing unit 403 calculates a feature amount of the whole page as one divided region, that is, the number of divisional.

The page-division processing unit 401 divides the page into four regions, 1 to 4, as shown in FIG. 5B and divides the layout information into each of the four divided regions to input to the feature-amount calculation processing unit 404. Accordingly, the feature-amount calculation processing unit 404 calculates a feature amount for every divided region shown in FIG. 5B.

The page-division processing unit 402 divides the page into twelve regions, 1 to 12 as shown in FIG. 5C and divides the layout information into each of the twelve divided regions to input to the feature-amount calculation processing unit 405. Accordingly, the feature-amount calculation processing unit 405 calculates a feature amount for every divided region shown in FIG. 5C.

The feature-amount calculation processing units 403, 404, and 405 calculate the following in each divided region, respectively, as feature amounts:

Area ratio of object of every attribute (title, character, graphics, photograph, table, and the like)

The number of objects

Area ratio of every object

An area ratio of an object for every attribute is a feature amount to measure a similarity of kind of object and structure inside the divided region. The number of objects and an area ratio for every object are feature amounts to measure a similarity of object structure unrelated to the attribute inside the divided region. When an area ratio for every object is calculated in respect of a predetermined number (equal to or more than one) of objects having a larger area ratio, changes in the number of feature amounts due to images can be prevented (however, when the number of objects in the divided region is smaller than the above predetermined number, this feature amount is set to zero.). The positional feature of object is automatically calculated by processing layout information on page having a larger number of divisions.

Since differences in the number of feature amounts due to dynamic object selection operation and image at the time of layout feature amount calculation are eliminated by constructing the layout-feature-amount calculation processing unit 115 as described above, it is advantageous to speed up similarity calculation processing at the time of similar image retrieval. Note that, in Japanese Patent Application Laid-Open No. 2000-285141, a technique that extracts an object corresponding to each object of a query image from an image to compare with the query image at the time of similar image retrieval and calculates a similarity through comparison of the position, size and attribute between these objects is disclosed. However, in this method, it becomes necessary to dynamically select an object of image whose similarity is calculated at the time of retrieval, and therefore, there is a fear that time consumed by similarity calculation processing is markedly increased. According to the layout feature amount calculation processing method according to the first embodiment, such dynamic object selection operation becomes unnecessary.

Note that the number of page divisions and the method of division in the layout feature amount calculation processing are not limited to the examples described above. By making divisions equal to one another regardless of image size, complication due to the difference in the number of divisions depending on image size can be absorbed. Further, when the number of divisions becomes larger, enhancement of the accuracy in respect of object shape can be expected.

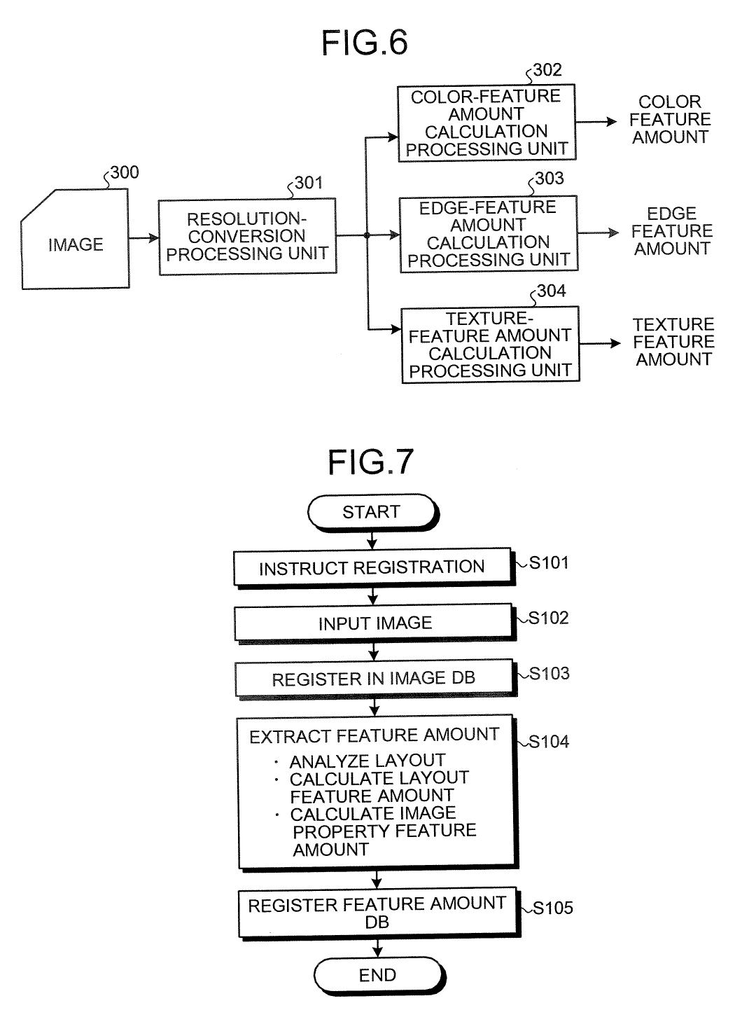

The image-property feature-amount calculation processing unit 114 will be explained next. The functional structure of the image-property feature-amount calculation processing unit 114 in a case where color, outline (edge), and pattern (texture) are selected as image properties, and feature amounts with respect to these properties are calculated is shown in FIG. 6. In FIG. 6, the reference numeral 301 represents a resolution conversion processing unit, 302 represents a color feature-amount calculation processing unit, 303 represents an edge feature-amount calculation processing unit, and 304 represents a texture feature-amount calculation processing unit.

To an input image 300, resolution conversion processing is carried out by the resolution conversion processing unit 301, and the input image 300 is converted to an image with a predetermined low resolution, followed by inputting to each of the feature-amount calculation processing units 403, 404, and 405. The aims to perform resolution conversion like this are as follows. Usually, a document image has a resolution of ca. 200 to 300 dpi in order to retain readability of characters; however, such a high resolution is not necessary for calculation of feature amounts of image properties. In addition, time consumed by calculation of feature amounts can be shortened when the resolution is lowered. Further, by making the resolution lower, local edges such as characters and dots in the input image are nullified. Therefore, enhancement of the accuracy of feature amount calculation can be expected. Note that when the input image 300 is an image having a low resolution and when shortening feature amount calculation processing time is not necessary, the resolution conversion processing may be omitted.

From the image data after the resolution conversion processing, a color feature amount is calculated by the color feature calculation processing unit 302, an edge feature amount is calculated by the edge feature-amount calculation processing unit 303, and a texture feature amount is calculated by the texture feature-amount calculation processing unit 304. Well-known techniques can be used for the calculation of these three kinds of feature amounts. For example, in respect of color feature amount, a color histogram and the like of the image may be used. For the color histogram, a technique in which an appropriate color space (for example, Lab, Luv, and HSV are common) is selected, the color space is divided into a plurality of regions, which region in the color space each pixel of the image corresponds to is checked, and the number of pixels in every region is normalized according to the number of the total pixels, thereby calculating the color feature amount can be used. The edge feature amount can be calculated using an appropriate edge extraction filter or the like. The texture feature amount can be obtained by texture extraction processing based on, for example, co-occurrence matrix (see “Handbook of Image Analysis” Supervising Editors, Mikio Takagi and Haruhisa Shimoda, University of Tokyo Press (1991)).

Operation at the time of image registration will be explained next with reference to the flowchart shown in FIG. 7. In FIG. 1, the broken lines inside the server apparatus 110 represent data flow at the time of image registration.

By inputting an instruction to register image data to the processing control unit 102 from the input device 103 by a user of the client apparatus 100, this registration instruction is transmitted to the server apparatus 110 via the external communication channel 104 by the processing control unit 102 (application program)(step S101), and the data of the image to be registered is input to the server apparatus 110 via, for example, the external communication channel 104 (step S102). This image data is captured via the external interface 111 and registered in the image DB 118 by control of the image-DB control processing unit 119 (step S103). The image data is also input to the layout analysis processing unit 113 and the image-property feature-amount calculation processing unit 114, layout information on the image is obtained by the layout analysis processing unit 113, a layout feature amount is calculated by the layout-feature-amount calculation processing unit 115 from this layout information, and an image property feature amount of the image is also calculated by the image-property feature-amount calculation processing unit 114 (step S104). The data of the layout feature amount and the image property feature amount of the image obtained as described above is correlated with the image (specifically, the same ID as that of the image is given as described above) and accumulated in the feature amount DB 117 (step S105).

Here, the image data and the feature amount data thereof are separately accumulated in the image DB 118 and the feature amount DB 117, respectively. However, it is also possible to employ a mode in which the image DB 118 and the feature amount DB 117 are integrated by accumulating image data and feature amount data in the same database as a hierarchical data structure with the use of a language, for example, eXtensible Markup Language (XML). Further, it is also possible to employ a mode in which either one of the image DB 118 and the feature amount DB 117 or both are provided to the outside of the server apparatus 110. Furthermore, although it was assumed that image data to be registered was input to the server apparatus 110 via the external communication channel 104, a mode in which image data is directly input to the server apparatus 110 from an image input device such as scanner or digital camera can also be employed.

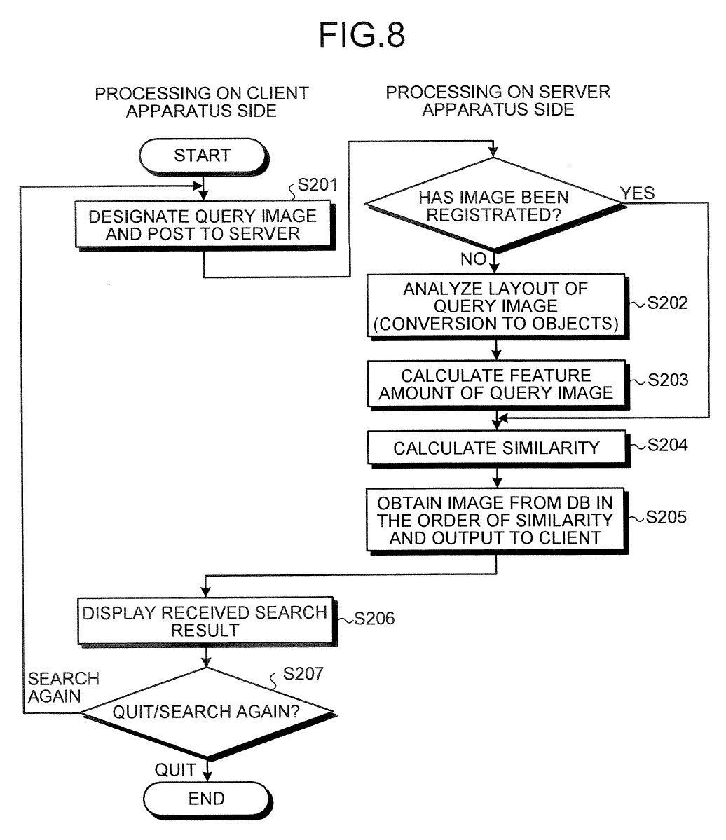

Operation of similar image retrieval will be explained next. FIG. 8 is a flowchart for this explanation. In FIG. 8, the steps shown on the left are processing steps performed by the client apparatus, and the steps on the right are performed by the server apparatus.

Step S201: On the client apparatus 100, a user designates a document image whose layout is thought similar to that of a document image (target image) that is desired to be retrieved to the processing control unit 102 via the input device 103 as a query image, as well as instructs similar image retrieval. The processing control unit 102 specifies the query image to the server apparatus 110 and posts the instruction of similar image retrieval.

As the query image, it is possible to specify an image having been registered in the image DB 118 as well as to select an image existing in an outside file. When an image existing in the outside file is specified as the query image, the query image is input via the external interface 111 through the external communication channel. This case is assumed in FIG. 1, which shows a query image 112 is input from the outside file. When an image having been registered in the image DB 118 is specified as the query image, capture of the query image itself is unnecessary and the processing at steps S203 and S203 is also unnecessary. When limitation to select the query image only from registered images is added and when the image DB 118 and the feature amount DB 117 are created separately in advance, it is also unnecessary to provide respective units 113, 114, and 115 to obtain feature amounts in the server apparatus 110. This is the same in the second embodiment and the third embodiment of the present invention.

Assuming that the query image 112 is input from the external file, the following processing will be explained here.

Step S202: The layout analysis processing in respect of the query image 112 is carried out by the layout analysis processing unit 113 to generate layout information.

Step S203: The image-property feature-amount calculation processing unit 114 calculates an image property feature amount of the query image 112. Further, the layout-feature-amount calculation processing unit 115 calculates a layout feature amount from the layout information input from the layout analysis processing unit 113. The image property feature amount and the layout feature amount that were calculated are input to the similarity calculation processing unit 116. When an image that has been registered in the image DB 118 is designated as the query image, the feature amount data related to the image is read out from the feature amount DB 117 to the similarity calculation processing unit 116.

Step S204: The similarity calculation processing unit 116 calculates a similarity between images using the layout feature amount and the image property feature amount of each registered image and the layout feature amount and the image property feature amount of the query image read out from the feature amount DB 117 and ranks the registered images in descending order of similarity. IDs of a predetermined number of registered images ranked as described above are output to the image-DB control processing unit 119. That is, images similar to the query image are retrieved at this stage.

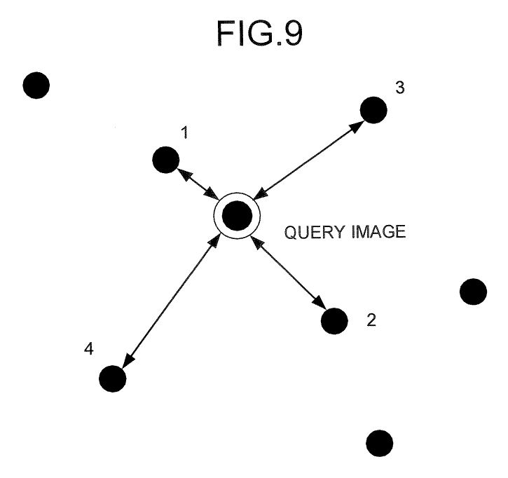

Here, similarity calculation processing in the similarity calculation processing unit 116 is explained with reference to FIG. 9. Feature amounts of registered images accumulated in the feature amount DB 117 are mapped for every kind of feature amount in the feature space as shown in FIG. 9. In similarity calculation, feature amounts of a query image are also similarly mapped in the feature space. The points (black dots) shown in FIG. 9 represent images mapped in the feature space, and the distance between the point of the query image and a point of each image becomes a similarity. Many of feature amounts of image are vector data, and an equation for vector distance definition such as Euclidean distance is commonly used for calculation of distance between points. A similarity of image is calculated by multiplying a similarity calculated for every feature amount by a weight.

That is, assuming that the number of layout feature amounts is n, a weight to each layout feature amount is Li, a similarity of each layout feature amount is Di, the number of image property feature amounts is m, a weight to each image property feature amount is Sj, a similarity of each image property feature amount is dj, a weight to the total layout feature amount is α, and a weight to the total image property feature amount is β, a similarity R of the image is calculated by by using following Equation 1. Note that α and β are set to be in the relation of α<β in Equation 1.

$$R = α {\sum }_{i = 1}^{n} Li \cdot Di + β {\sum }_{j = 1}^{m} Sj \cdot dj \qquad ( 1 )$$

In this example, because the similarity of each feature amount is a distance, the similarity R of an image means that as the value of the similarity R is smaller, the similarity is higher. In other words, setting Ca smaller than β (α<β) means that a weight to a layout feature amount is made more significant than that to an image property feature amount at the time of similarity calculation.

It may be accepted that Li and Sj are multiplied by values of α and β in advance, respectively, and the weights to all layout feature amounts may be set so as to be more significant than weights to image property feature amounts. Here, Li and Sj can be regarded as coefficients to normalize each feature amount. α and β are used for intentional ranking. Processing so as to make the specific weights of Li and Sj heavier may also be carried out by user setting. Further, the weights of α and β may be similarly changed according to user instructions.

In this way, similar image retrieval in which layout characteristics are given more importance (global information on page is prioritized) becomes possible by making a weight of layout feature amount heavier (emphasized) than that of image property feature amount. According to the similar image retrieval in which priority is given to such global information, it is possible with ease to reach a target image by narrowing down images relying on an uncertain memory related to the target image.

Step S205: As described above, the similarity calculation processing unit 116 inputs IDs of images ranked in descending order of similarity to the image-DB control processing unit 119. The image-DB control processing unit 119 reads out data of the ranked images from the image DB 118 in order with the use of the IDs and transmits it to the client apparatus 100 via the external interface 111 through the external communication channel 104.

Step S206: The processing control unit 102 of the client apparatus 100 displays images received from the server apparatus 110 on the display device 101 in descending order of similarity. The method of displaying in this case is not particularly limited, and for example, a list of thumbnail display common in similar image retrieval can be used.

The user confirms whether the target image is included in the images displayed on the display device 101. When the target image is found, an instruction “quit search” is input from the input device 103, and the similar image retrieval can be terminated. When the target image is not included in the displayed images, an instruction “search again” is input, and the similar image retrieval can be continued.

Step S207: When the user inputs the instruction “search again”, similar image retrieval can be instructed by way of designating a new query image. At this time, it is possible that an image whose layout is the most alike to the target image remembered is selected among the images retrieved last time that are displayed on the display device 101 and that the selected image can be designated as the new query image. In other words, retrieval to narrow down with the use of the last search result is possible. Of course, a completely different image can also be designated as the query image. Such designation of query image and instruction of similar image retrieval are posted to the server apparatus 110 by the processing control unit 102.

On the other hand, similar image retrieval is carried out in the server apparatus 110 according to the processing flow similar to the case of the last instruction of similar image retrieval.

As described above, because the retrieval starts using the query image whose layout is thought close to the target image remembered, the possibility of inclusion of the target image in the search result is not necessarily high at the initial stage of the retrieval. However, the possibility of inclusion of an image closer to the target image than the first query image in the search result is high. Therefore, by repeating recursive retrieval that an image close to the target image in the search result is selected as the query image and retrieval is carried out again, similarity between the query image and the target image gradually becomes higher, resulting in rise of the display order of the target image in the registered images. This brings about an effect that the target image is hauled up. In addition, the weight to the layout feature amount is made heavier (emphasized) than that of the image property feature amount at the time of similarity calculation as described above, and similar image retrieval in which priority is given to layout (global information on page) is carried out. Accordingly, images are narrowed down relying on an uncertain memory related to the target image, and reaching the target image with ease is possible, and therefore, the usability is markedly enhanced. Note that, when a target image could not be narrowed down in conventional text-based search, complex and ineffective work to confirm many images by a user was required.

In the first embodiment, the layout analysis processing and the feature amount calculation processing have been explained assuming that the image is a raster image like scan data. Even in cases of image data generated by various application software and image data in portable document format (PDF), the image data can be similarly handled by rasterizing them, and a structure in which layout analysis can be carried out using the structural information on such image data can also be constructed.

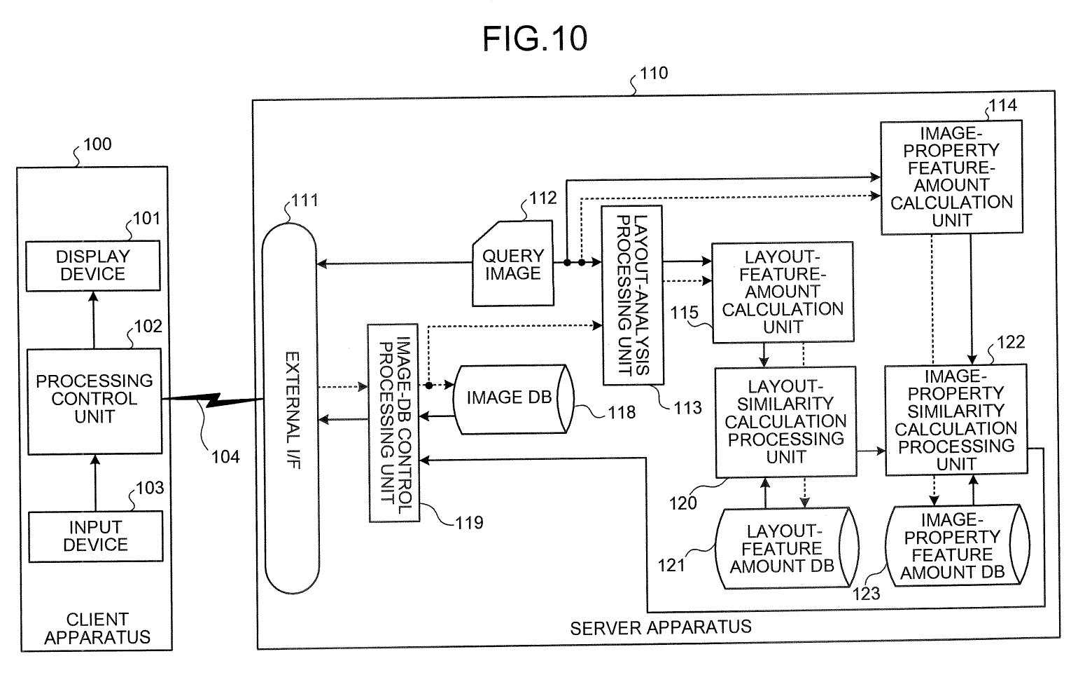

FIG. 10 is a block diagram of a similar image retrieval apparatus according to a second embodiment of the present invention. The differences from the first embodiment will be explained next.

In the second embodiment, the feature amount DB 117 is divided into a layout-feature amount DB 121 and an image-property feature amount DB 123. At the time of image registration, layout feature amounts calculated by the layout-feature-amount calculation processing unit 116 are accumulated in a layout-feature amount DB 121 correlated with images, image property feature amounts calculated by the image-property feature-amount calculation processing unit 114 are correlated with the images and then accumulated in an image-property feature amount DB 123. However, the feature amount DB is not necessarily divided physically into two.

Further, the similarity calculation processing unit is divided into a layout-similarity calculation processing unit 120 and an image-property similarity calculation processing unit 122. The layout-similarity calculation processing unit 120 is an unit that, at the time of similar image retrieval, calculates similarities between a query image and registered images (referred to as layout similarity), respectively, using layout feature amounts and carries out processing to rank the registered images in descending order of layout similarity. The image-property similarity calculation processing unit 122 is an unit that, at the time of the similar image retrieval, calculates similarities (referred to as image property similarity) between the query image and a predetermined number of the registered images on a ranking basis that have been ranked according to the layout similarities using image property feature amounts and re-ranks the registered images in descending order of image property similarity. That is, global ranking is performed according to layout features and then local ranking changes are performed according to image property features.

When explained in more detail, the layout-similarity calculation processing unit 120 calculates a layout similarity between the query image and a registered image by following Equation 2 using only layout feature amounts. Since ranking is performed in two steps as described above, the weight α used in Equation 1 is unnecessary.

$$R = {\sum }_{i = 1}^{n} Li \cdot Di \qquad ( 2 )$$

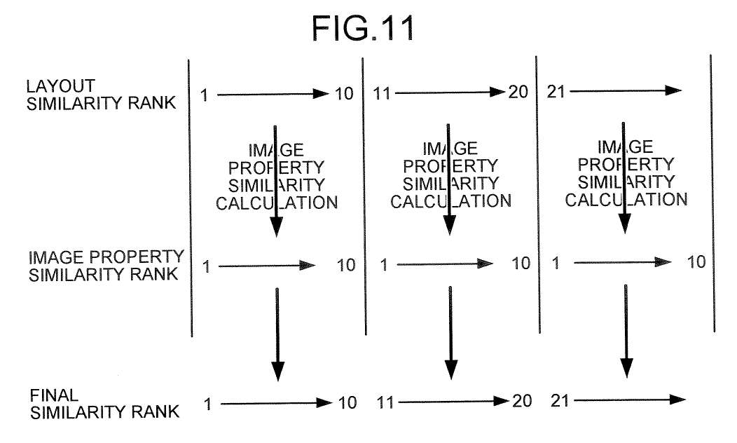

Assume that ranking of the registered images was carried out in descending order of layout similarity as shown, for example, in the upper row in FIG. 11 by the layout similarity calculation processing.

Next, the registered images ranked according to the layout similarities are divided, for example, into every ten ordinal ranks, and the image-property similarity calculation processing unit 122 calculates image property similarities between the query image and the divided ten registered images, respectively, using image property feature amounts. In this case, the calculation is carried out by Equation 3:

$$R = {\sum }_{j = 1}^{10} Sj \cdot dj \qquad ( 3 )$$

In the image property similarity calculation processing, the registered images in the first to the tenth ranks according to the layout similarities are re-ranked in descending order of image property similarity as shown in the middle row in FIG. 11. The registered images in the eleventh to twentieth ranks and the registered images in the twenty-first to the thirtieth ranks according to the layout similarities are also re-ranked similarly in descending order of image property similarity. As the result, ranking is eventually performed as shown in the lower row in FIG. 11.

According to the final ranking, IDs of registered images corresponding to the ranks are sent to the image-DB control processing unit 119, whereby images having the IDs are read out in the order of the rank and sent to the client apparatus 100, followed by displaying the images on the display device 101 as the search result.

As is evident from the above explanation, in the second embodiment as well, the global similarity order is determined by layout features of images, and therefore, the target image can be narrowed down with ease relying on an uncertain memory about the layout of the target image, thereby allowing similar image retrieval with excellent usability.

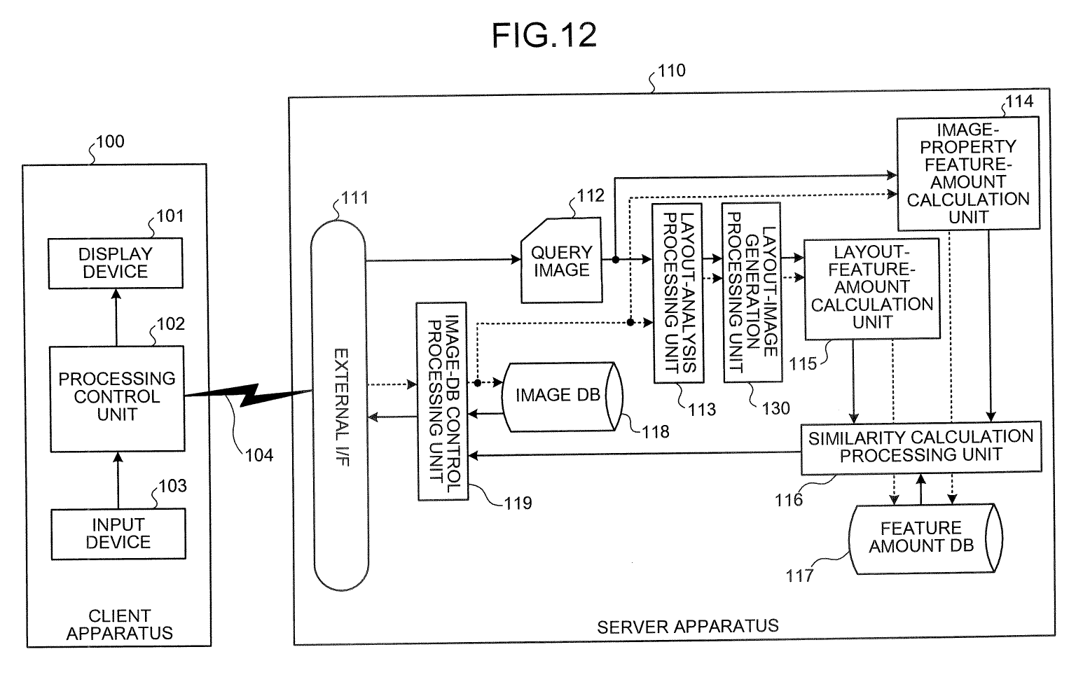

FIG. 12 is a block diagram of a similar image retrieval apparatus according to the third embodiment. The differences from the first embodiment will be explained next.

In the third embodiment, a layout image generation processing unit 130 is added between the layout analysis processing unit 113 and the layout-feature-amount calculation processing unit 115 and the structure of the layout-feature-amount calculation processing unit 115 is changed.

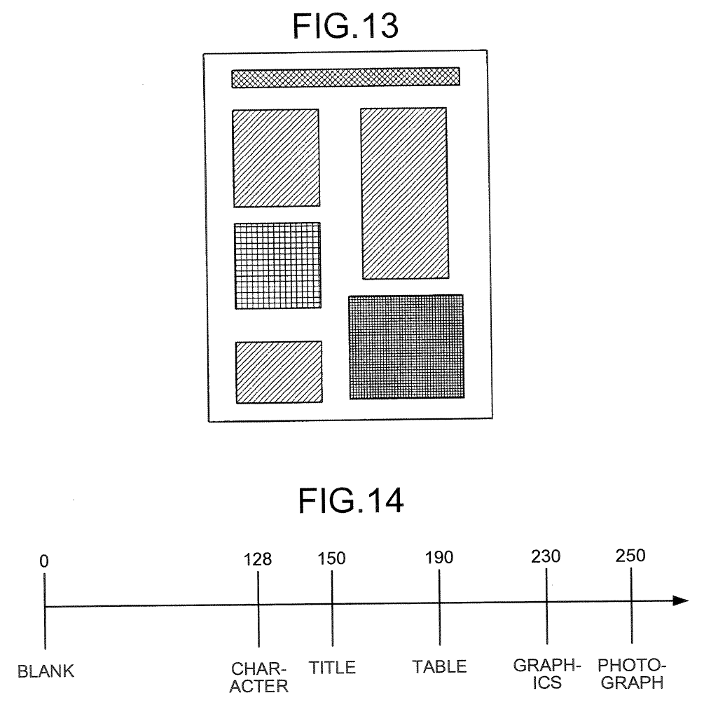

The layout image generation processing unit 130 is an unit that, using input of layout information from the layout analysis processing unit 113, generates an image (layout image) in which each object in the image is marked according to the attributes thereof. For this marking, a method of filling in an object with uniform data corresponding to the attribute thereof or a method of filling in the object with a texture corresponding to the attribute can be used. For example, when the document image shown in FIG. 3A is divided into objects like the ones in FIG. 3B by layout analysis, a layout image as if each object in FIG. 3B were filled in with uniform data corresponding to the attribute or a marking image that each object shown in FIG. 13 is filled in with a texture corresponding to the attribute is generated.

The marking method in which objects are filled in with uniform data corresponding to the attributes, respectively, would be preferred because processing is simple and the structure of the layout-feature-amount calculation processing unit 115 becomes simple.

In the marking method to fill in with uniform data, it is possible to convert attributes into numbers according to data to fill with. In this case, a similarity of attribute can be correlated with the value of the data to fill with. This is explained with reference to FIG. 14.

FIG. 14 is a detailed diagram to explain conversion into numbers where similarities of attributes are taken into consideration. For example, when kinds of attribute in attribute determination are set to character, title, table, graphics, and photograph, the attribute most similar to character is set to title, which is sequentially followed by table, graphics, and photograph, and a distance is set according to each similarity degree to convert into numbers. For example, assuming that “because similarity between character and title is high, the distance between them is close.”, “because similarity between photograph and graphics is high, the distance between them is close”, and so forth, and for example, blank is converted into 0, character into 128, title into 150, table into 190, graphics into 230, and photograph into 250, and an object corresponding to the attribute is filled in with the numerical value thereof. By this way, it is possible to calculate a layout similarity by converting a similarity of attribute into a number without handling an object different in attribute as a completely different object. When an object is indicated by a numerical value corresponding to the attribute thereof in this way, an image output from the layout image generation processing unit 130 becomes a gray image. Note that attributes may be indicated by colors instead of numerical values.

In the case of the marking method in which an object is filled in with a texture corresponding to the attribute thereof, a texture having a high similarity can be used for an object having a high attribute similarity. The layout image shown in FIG. 13 is an example in which the objects are filled in with textures in consideration of attribute similarity, and a diagonal line texture is used for an object of character type and a horizontal and vertical line texture is used for an object of photograph type.

A layout feature amount can be calculated by the layout-feature-amount calculation processing unit 115 by the processing similar to that carried out by the image-property feature-amount calculation processing unit 114. However, in the case of the method of marking objects with textures, the use of color feature amount is not necessary.

In the third embodiment, because a layout attribute can be indicated according to the attribute similarity when a layout feature amount is calculated from the layout image generated from the layout information, it becomes possible to reduce the influence exerted by handling images different from each other in object attribute as images with low similarity, and narrowing-down of image relying on an uncertain memory of a person can be facilitated, thereby enhancing the usability.

The third embodiment is based on the structure of the first embodiment and may also be based on the structure of the second embodiment. In other words, a structure in which the layout image generation processing unit 130 is inserted between the layout analysis processing unit 113 and the layout-feature-amount calculation processing unit 130 in the structure of the second embodiment may be accepted.

The method or the apparatus for retrieving a similar image of the present invention is the most suitable for the use of retrieval of a target image relying on an uncertain memory thereof. That is, the methods or the apparatuses for retrieving a similar image according to the embodiments carry out retrieval of a similar image in which priority is given to layout that is global information on image by way of ranking retrieval target images according to similarities calculated using the layout feature amounts and the image property feature amounts obtained from the retrieval target images and the query image as well as assigning a heavier weight to the layout feature amount than to the image property feature amount. The methods or the apparatuses for retrieving a similar image according to the embodiments carry out retrieval of a similar image in which priority is given to layout by way of ranking the retrieval target images according to similarities calculated using the layout feature amounts obtained from the retrieval target images and the query image, and finally ranking the ranked retrieval target images in separate groups according to the similarities calculated using the image property feature amounts obtained from the retrieval target images and the query image. Moreover, because the layout feature amounts obtained from the images are used, it is not necessary for a user to designate layout information. According to the similar image retrieval in which priority is given to layout as described above, because an image whose layout is close to that of the target image is retrieved by way of using a query image whose layout is thought close to that of the target image, the target image can be narrowed down with ease relying on an uncertain memory about the target image by repeating retrieval using an image thought to be closer to the target image among the retrieved images as the query image, and the designation of the layout information by the user is not necessary, thereby enhancing the search usability. The similar image retrieval apparatus according to the embodiments makes it possible to calculate highly accurate feature amounts for similarity calculation. Further, in the similar image retrieval apparatus according to the embodiments, differences in selection operation of dynamic objects and the number of feature amounts depending on images at the time of layout feature amount calculation are eliminated, and therefore the apparatus is advantageous in view of maintaining high speed of similarity calculation processing. The similar image retrieval apparatus according to the embodiments makes it possible to indicate an attribute of layout according to the similarity of the attribute when a layout feature amount is calculated from a layout image generated from the layout information, and therefore, it is possible to reduce the influence exerted by handling images different from each other in object attribute as images with low similarity. According to the programs according to the embodiments, or the program recorded in an information recording medium according to the embodiments, the similar image retrieval apparatuses according to the embodiments can be realized with ease using a computer.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method of retrieving similar image comprising:
calculating a similarity between each of a plurality of retrieval target images and a query image by using a layout feature amount and an image-property feature amount, the layout feature amount being a feature amount related to layout obtained from the retrieval target images and the query image, and the image-property feature amount being a feature amount related to properties other than the layout, wherein the layout feature amount is assigned with a heavier weigh than the image-property feature amount at the time of calculating the similarity; and
ranking the retrieval target images in descending order of similarities calculated at the calculating.

2. A method of retrieving similar image comprising:
first calculating including calculating a similarity between each of a plurality of retrieval target images and a query image by using a layout feature amount, the layout feature amount being a feature amount related to layout obtained from the retrieval target images and the query image;
ranking the retrieval target images in descending order of similarities calculated at the first calculating;
dividing the retrieval target images that are ranked at the ranking into at least two groups in a predetermined number on a ranking basis;
second calculating including calculating, for each group, a similarity between each of a plurality of retrieval target images in the group and the query image by using an image-property feature amount, the image-property feature amount being a feature amount related to properties other than the layout obtained from the retrieval target images and the query image; and
ranking the retrieval target images in the group in descending order of similarities calculated at the second calculating.

3. A similar image retrieval apparatus comprising:
a similarity calculating unit that calculates a similarity between each of a plurality of retrieval target images and a query image by using a layout feature amount and an image-property feature amount, the layout feature amount being a feature amount related to layout obtained from the retrieval target images and the query image, and the image-property feature amount being a feature amount related to properties other than the layout, wherein the layout feature amount is assigned with a heavier weigh than the image-property feature amount at the time of calculating the similarity; and
a ranking unit that ranks the retrieval target images in descending order of similarities calculated by the similarity calculating unit.

4. A similar image retrieval apparatus comprising:
a first calculating unit that calculates a similarity between each of a plurality of retrieval target images and a query image by using a layout feature amount, the layout feature amount being a feature amount related to layout obtained from the retrieval target images and the query image;
a first ranking unit that ranks the retrieval target images in descending order of similarities calculated by the first calculating unit;
a dividing unit that divides the retrieval target images that are ranked by the first ranking unit into at least two groups in a predetermined number on a ranking basis;
a second calculating unit that calculates, for each group, a similarity between each of a plurality of retrieval target images in the group and the query image by using an image-property feature amount, the image-property feature amount being a feature amount related to properties other than the layout obtained from the retrieval target images and the query image; and
a second ranking unit that ranks the retrieval target images in the group in descending order of similarities calculated by the second calculating unit.
